(19) United States
(12) Patent Application Publication
(10) Pub. No.: US 2014/0081952 A1
(43) Pub. Date: Mar. 20, 2014

(54) METHOD AND APPARATUS USING ITEM SEQUENCE OF SEQUENCE TABLE AS IDENTIFIER

(71) Applicant: Heung Soo LEE, Seoul (KR)

(72) Inventor: Heung Soo Lee, Seoul (KR)

(21) Appl. No.: 14/003,515

(22) PCT Filed: Apr. 8, 2013
(86) PCT No.: PCT/KR2013/002912

§ 371 Date: Sep. 6, 2013

(30) Foreign Application Priority Data
Apr. 19, 2012 (KR) 10-2012-0040752

(51) Int. Cl. G06F 17/30

(52) U.S. Cl. CPC G06F 17/30153
USPC 707/722

(57) ABSTRACT

A method and an apparatus using an item sequence of a sequence table as an identifier are provided. A data processing method includes the steps of: (a) causing the user apparatus to receive operation information to be transmitted from the information provider apparatus, wherein the operation information includes a plurality of data elements arranged in accordance with an item sequence of a sequence table in which the sequence of a plurality of items is specified and each data element includes one or more detailed operation data pieces; (b) extracting the data element of the item sequence corresponding to a reference position of the user apparatus out of the operation information; and (c) performing a predetermined operation using the one or more detailed operation data pieces included in the extracted data element.

### CROSS-REFERENCE TO RELATED APPLICATIONS

This application is a national stage entry under 35 U.S.C. 371(c) of International Application No. PCT/KR2013/002912, filed Apr. 8, 2013, and claims priority based on Korean Patent Application No. 10-2012-0040752, filed Apr. 19, 2012, the disclosures of all of which are incorporated herein by reference in their entireties.

### BACKGROUND

1. Field

The present invention relates to a method and an apparatus using an item sequence of a sequence table as an identifier.

2. Description of the Related Art

With recent advancement of data communications, data volumes to be transmitted through wired or wireless networks have increased more and more. Accordingly, it is necessary to efficiently use shares of communication bands.

A representative example of a data transmitting and receiving system is an intelligent transport system (ITS). The intelligent transport system is a traffic system in which techniques of electronics, information, communications, control, and the like are combined into a traffic system and is intended to make a speedy, safe, and comfortable next-generation traffic system suitable for accelerated transition into an information-oriented society.

The architecture of the intelligent transport system can be classified into a field of traffic control, a field of public transportation, a field of electronic payment, a field of traffic information distribution, a field of travel information provision, a field of intelligent driveway, and a field of cargo delivery, and can also be classified into collection, processing, and provision of traffic information depending on a flow of traffic information.

FIG. 1 is a diagram schematically illustrating a configuration of an intelligent transport system.

Referring to FIG. 1, the intelligent transport system 1 includes one or more traffic data collecting apparatuses 10, a traffic control center terminal 20, and one or more traffic information utilizing apparatuses 30.

The traffic data collecting apparatuses 10 serve to collect traffic data. For example, the traffic data collecting apparatuses are installed in a traffic data collecting vehicles such as probe cars or in vehicles traveling in regular routes such as regular buses to acquire traffic data using a GPS module, a timer, and the like, or are installed at crossroads and the like to acquire traffic data on vehicles passing through the corresponding crossroads using an image sensor, a contact sensor, a weight sensor, and the like

The traffic data collected by the traffic data collecting apparatuses 10 includes a variety of data such as positions, interval speeds, traffic volumes, queue information, signal light control information, and predicted information of stoppage time (for example, the number of passengers getting on and off and the number of buses stopping at a station) of vehicles (for example, probe cars and regular buses) of which information should be collected.

A variety of traffic information collected by the traffic data collecting apparatuses 10 is transmitted to the traffic control center terminal 20 through wired or wireless networks. The traffic control center terminal 20 processes the traffic data transmitted from the traffic data collecting apparatuses 10 on the basis of predetermined data processing methods (for example, decoding and encoding) to create traffic information and stores the created traffic information in a storage unit (for example, a database).

The traffic control center terminal 20 transmits the traffic information stored in the storage unit to the traffic information utilizing apparatuses 30 requiring the traffic information every predetermined time or when the traffic information is changed.

Examples of the traffic information utilizing apparatuses 30 include signal controllers controlling signal lights for traveling of vehicles or/and pedestrians at crossroads, regular bus terminals for adjusting intervals from a preceding bus or/and a following bus, station terminals for informing buses to arrive and estimated times of arrival, and navigation terminals for informing present traffic situations and the optimal (or the shortest) route to a destination. Mobile terminals such as smart phones having an application program regular bus information of bus routes designated by a user are also often used as the traffic information utilizing apparatuses 30.

In the intelligent transport system 1 shown in FIG. 1, the provision of traffic information from the traffic control center terminal 20 to the traffic information utilizing apparatuses 30 is mainly carried out by bidirectional communications. Accordingly, there is a problem in that data volumes to be transmitted are large to receive responses to transmission or the like, thereby increasing communication cost and facility cost.

FIG. 2 is a diagram illustrating a data format of traffic information in the related art.

Traffic information 50 has a data format including link IDs and sets of data elements 51a, 15b, and 51c (hereinafter, collectively referred to as 51) having information corresponding to the link IDs.

A node represents a point in a road, for example, an intersection, and a link represents a road lane connecting a node and another node. The link IDs are identifiers for identifying the links. The information corresponding to a link ID is detailed traffic data (for example, traveling speed) in the identified link, that is, in the identified road lane.

Referring to FIG. 2, the traffic information 50 includes only the data elements 51 corresponding to the links identified by identifiers ID1, ID3, and ID7. This is because transmission of detailed traffic data of all the links causes an increase in data volume. Therefore, the data format is formed to selectively transmit only detailed traffic data generated or changed recently. That is, the traffic information 50 shown in FIG. 2 represents that information 1, information 3, and information 7 are changed in the links identified by ID1, ID3, and ID7.

When traffic information having this data format is transmitted to an information processing terminal installed in a vehicle from the traffic control center, the traffic information may be received or may not be received depending on the position or state of the vehicle. For example, when the vehicle is located in an underground parking lot or the information processing terminal receiving the traffic information is turned off for a long time due to parking of the vehicle or the like, the traffic information may not be received by the vehicle.

A method of re-transmitting the traffic information may be used for this case. However, re-transmission of data of which details have not been changed causes an increase of the total data volume to be stored and transmitted by the traffic control center, thereby increasing the total cost.

FIG. 3 is a diagram illustrating another data format of traffic information in the related art.

Traffic information 60 shown in FIG. 3 has a data format including link IDs and sets of data elements 61a, 61b, and 61c (hereinafter, collectively referred to as 61) having information corresponding to the link IDs, similarly to the traffic information shown in FIG. 2. The traffic information 60 shown in FIG. 3 includes overall detailed traffic data instead of including only the detailed traffic data recently created or changed.

When the overall detailed traffic data is transmitted, all traffic situations can be sufficiently grasped using traffic information received latest by a terminal installed in a vehicle, even if the traffic data cannot be received due to the position or state of the vehicle.

However, in this case, since the overall detailed traffic data should be transmitted, there is a problem in that the data volume to be transmitted every time is much larger than that in the case shown in FIG. 2. Particularly, since the link IDs (ID1, ID2, . . . , IDn) which are identifiers for identifying links should be configured to be unique and to be easily understood, there is a problem in that the length thereof is elongated, thereby causing an increase of the total data volume of the traffic information.

Korean Patent Application Laid-open No. 10-2001-0085799, which was filed by the applicant of the present invention, discloses a method and a system for providing time-variant geographical information and a user apparatus thereof which can enhance transmission efficiency by changing a data format of traffic information, but does not disclose designation or change of a sequence thereof.

The data transmitting and receiving system is assumed above to be an intelligent transport system, but there is a need for reducing a data volume to be transmitted when it is intended to control apparatuses (for example, streetlights or power facilities) which can be identified by IDs in a streetlight system or a power facility system.

### SUMMARY

An object of the invention is to provide a method and an apparatus using an item sequence of a sequence table, which can reduce a data volume of existing identifiers to reduce a data volume to be transmitted by using an item sequence of a sequence table which are commonly stored by both a transmission party and a reception party.

Another object of the invention is to provide a method and an apparatus using an item sequence of a sequence table, which can reduce an error due to communication congestion in the course of transmitting information, reduce communication cost and facility cost, and improve data quality.

Another object of the invention is to provide a method and an apparatus using an item sequence of a sequence table, which can transmit the same information with a volume smaller than that in the related art and greatly enhance a reception success rate when data should be re-transmitted in transmission via a broadcast network.

Other objects of the invention will be easily understood from the following description.

According to an aspect of the invention, there are provided a data processing method using an item sequence of a sequence table as an identifier in a user apparatus connected to an information provider apparatus via a network and a recording medium having recorded thereon a program for performing the data processing method.

The data processing method includes the steps of: (a) causing the user apparatus to receive operation information to be transmitted from the information provider apparatus, wherein the operation information includes a plurality of data elements arranged in accordance with an item sequence of a sequence table in which the sequence of a plurality of items is specified and each data element includes one or more detailed operation data pieces; (b) extracting the data element of the item sequence corresponding to a reference position of the user apparatus out of the operation information; and (c) performing a predetermined operation using the one or more detailed operation data pieces included in the extracted data element.

The user apparatus may store the sequence table or reference position information based on the sequence table.

The data processing method may further include a step of causing the user apparatus receives item arrangement information of a changed sequence table and to rearrange the items of the sequence table stored in the user apparatus in response to the received item arrangement information, when the sequence table is changed in the information provider apparatus.

The data processing method may further include a step of causing the user apparatus to receive and store information on a reference position of the user apparatus which is newly created or changed on the basis of a newly-created or changed sequence table, when the sequence table is newly created or changed in the information provider apparatus.

The data processing method may further include a step of causing the user apparatus to receive and store a newly-created or changed sequence table, when the sequence table is newly created or changed in the information provider apparatus.

The data processing method may further include a step of causing the user apparatus to receive item arrangement information of a newly-created sequence table and to create and store a sequence table having an item sequence corresponding to the item arrangement information, when the sequence table is newly created in the information provider apparatus, before the step of (b).

The step of (a) may include causing the user apparatus to receive the sequence table along with the operation information, and the user apparatus may store the received sequence table before the step of (b).

The operation information may be included in a broadcast signal emitted from the information provider apparatus via a broadcast network.

The operation information may include a sequence table identifier for identifying a sequence table in which the sequence of a plurality of items is specified, and the step of (b) may include causing the user apparatus to confirm the reference position using the sequence tables corresponding to the sequence table identifiers.

The items of the sequence table may indicate other sequence tables.

According to another aspect of the invention, there is provided a data creating method using an item sequence of a sequence table as an identifier in an information provider apparatus connected to a user apparatus via a network and a recording medium having recorded thereon a program for performing the data creating method.

The data creating method includes the steps of: (a) causing the information provider apparatus to create a sequence table in which a sequence of a plurality of items is specified depending on an attribute of the user apparatus; (b) creating operation information including a plurality of data elements which are arranged in the item sequence of the sequence table, wherein each data element includes one or more detailed operation data pieces; and (c) transmitting the operation information to the user apparatus.

The data creating method may further include a step of: causing the information provider apparatus to transmit one or more of the newly-created or changed sequence table, item arrangement information of a newly-created or changed sequence table, and a reference position of the user apparatus based on the newly-created or changed sequence table, when the sequence table is newly created or changed.

The operation information transmitted in the step of (c) may be included in a broadcast signal emitted from the information provider apparatus via a broadcast network.

The operation information may include a sequence table identifier for identifying a sequence table in which a sequence of a plurality of items is specified.

The items of the sequence table may indicate other sequence tables.

Other aspects, features, and advantages of the invention will become apparent from the accompanying drawings, the appended claims, and the detailed description of the invention.

### BRIEF DESCRIPTION OF THE DRAWINGS

FIG. 1 is a diagram schematically illustrating a configuration of an intelligent transport system.

FIG. 2 is a diagram illustrating a data format of traffic information in the related art.

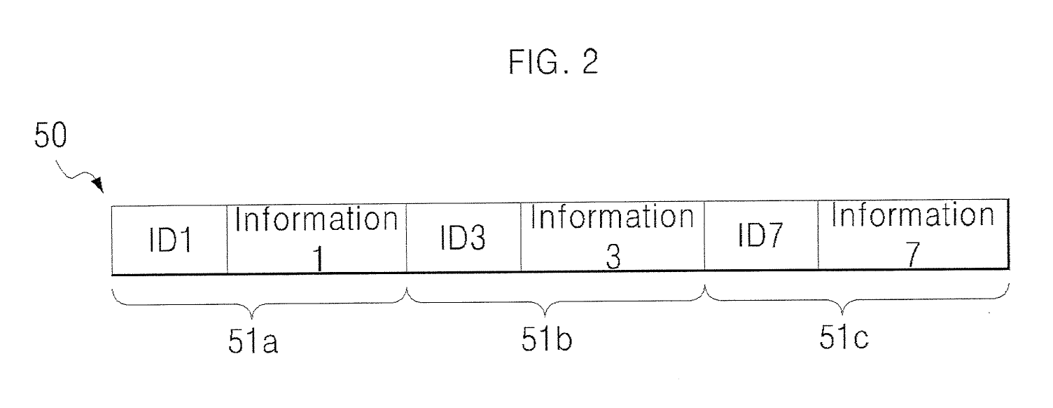

FIG. 3 is a diagram illustrating another data format of traffic information in the related art.

FIG. 4 is a diagram schematically illustrating a configuration of a traffic control center terminal according to an embodiment of the invention.

FIG. 5 is a flowchart illustrating a traffic information creating method which is performed by the traffic control center terminal according to the embodiment of the invention.

FIG. 6 is a diagram illustrating an example of traffic information having a predetermined data format, which is processed by a data processing unit of the traffic control center terminal according to the embodiment of the invention.

FIG. 7 is a diagram illustrating an example of a sequence table.

FIG. 8 is a diagram illustrating examples of a sequence table of traffic information created by the traffic control center terminal according to the embodiment of the invention.

FIG. 9 is a diagram illustrating examples of traffic information.

FIG. 10 is a diagram schematically illustrating a configuration of a traffic information utilizing apparatus according to the embodiment of the invention.

FIG. 11 is a flowchart illustrating a data processing method which is performed by the traffic information utilizing apparatus according to the embodiment of the invention.

FIG. 12 is a diagram illustrating a method using a sequence table and an item sequence as identifiers according to another embodiment of the invention.

FIG. 13 is flowchart illustrating a data creating method using an item sequence of a sequence table as an identifier, which is performed by an information provider apparatus in a data transmitting and receiving system according to the invention.

FIG. 14 is a flowchart illustrating a data processing method using an item sequence of a sequence table as an identifier which is performed by a user apparatus in the data transmitting and receiving system according to the invention.

### DETAILED DESCRIPTION

The invention can be modified in various forms and specific embodiments will be described and shown below. However, the embodiments are not intended to limit the invention, but it should be understood that the invention includes all the modifications, equivalents, and replacements belonging to the concept and the technical scope of the invention. When it is determined that detailed description of known techniques involved in the invention makes the gist of the invention obscure, the detailed description thereof will not be made.

Terms such as “first” and “second” can be used to describe various elements, but the elements are not limited to the terms. The terms are used only to distinguish one element from another element.

The terms used in the following description are intended to merely describe specific embodiments, but not intended to limit the invention. An expression of the singular number includes an expression of the plural number, so long as it is clearly read differently. The terms such as “include” and “have” are intended to indicate that features, numbers, steps, operations, elements, components, or combinations thereof used in the following description exist and it should thus be understood that the possibility of existence or addition of one or more other different features, numbers, steps, operations, elements, components, or combinations thereof is not excluded.

A term such as “unit” described in the specification means a unit for performing at least one function or operation and can be embodied by hardware, by software, or by a combination of hardware and software.

Hereinafter, embodiments of the invention will be described in detail with reference to the accompanying drawings. In describing the invention with reference to the accompanying drawings, like elements will be referenced by like reference numerals or signs regardless of the drawing numbers and description thereof will not be repeated.

The invention can be applied to a data transmitting and receiving system including an information provider apparatus that creates and transmits data of a predetermined format and a user apparatus that receives and processes the data. In the following description, it is assumed that the data transmitting and receiving system is an intelligent transport system, for the purpose of facilitating understanding and explanation of the invention.

However, this assumption is not intended to limit the scope of the invention. The same technical concept is applicable when the data transmitting and receiving system is a system (for example, a streetlight system or a power facility system) including an information provider apparatus that creates and transmits control information on apparatuses (for example, streetlights or power facilities) which can be identified by IDs and user apparatuses that are installed in the apparatuses to be controlled.

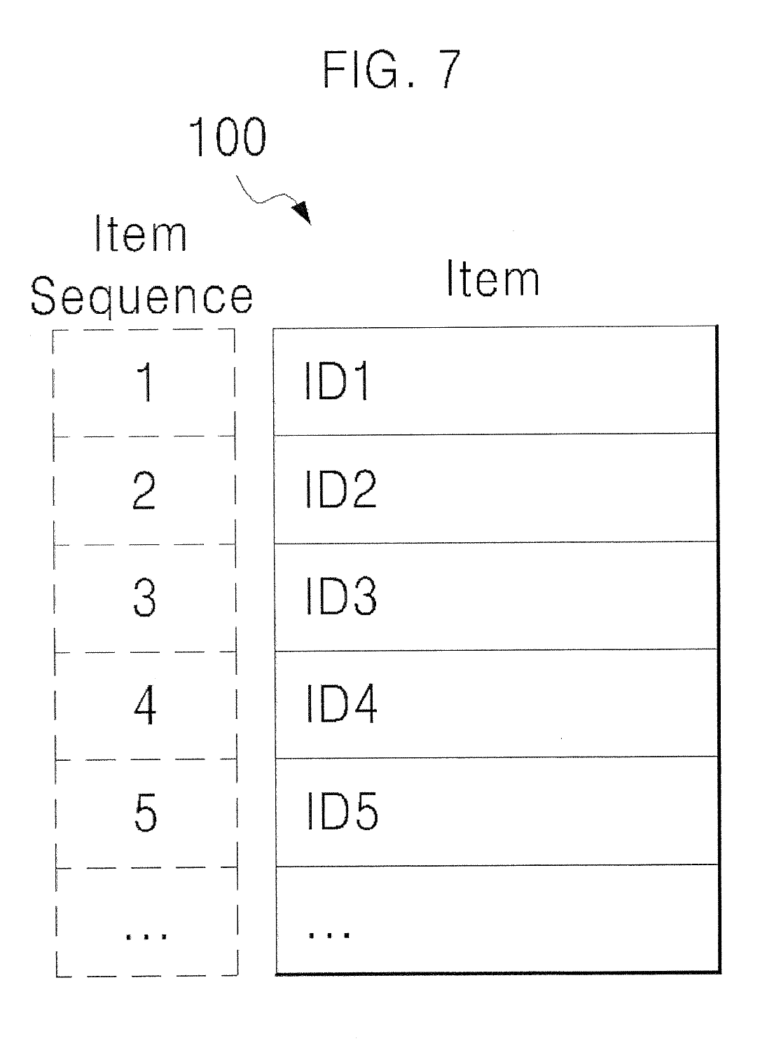

In this specification, an “item sequence” means sequence information sequentially given to items in accordance with an arrangement order of the items when information pieces considered as the items are arranged in an order of rows and/or columns in accordance with a predetermined rule, as described later with reference to FIG. 7 and the drawings subsequent thereto. The “item sequence” may be expressed as an item order, an item sequence number, an item number, and the like.

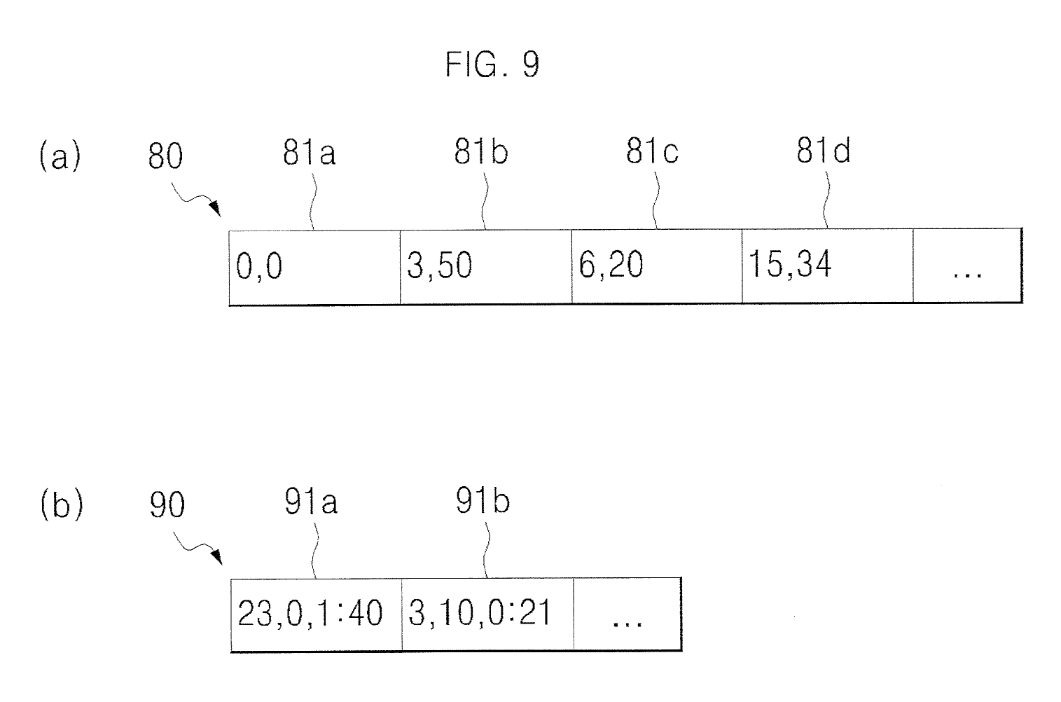

For example, in FIG. 7, when information pieces corresponding to items are arranged in plural rows, the item sequence is given to the items so as to match the order of rows. In FIG. 9, when information pieces corresponding to items are arranged in plural fields of a single row, an item sequence is given to the items so as to match the order of fields. That is, when a table including information on one or more items is input, information pieces corresponding to the items are extracted from the table, the rule of the rows and/or columns in which the information pieces are arranged is recognized, and the item sequence is sequentially given to the items in accordance with the arrangement order of the items corresponding to the recognized rule.

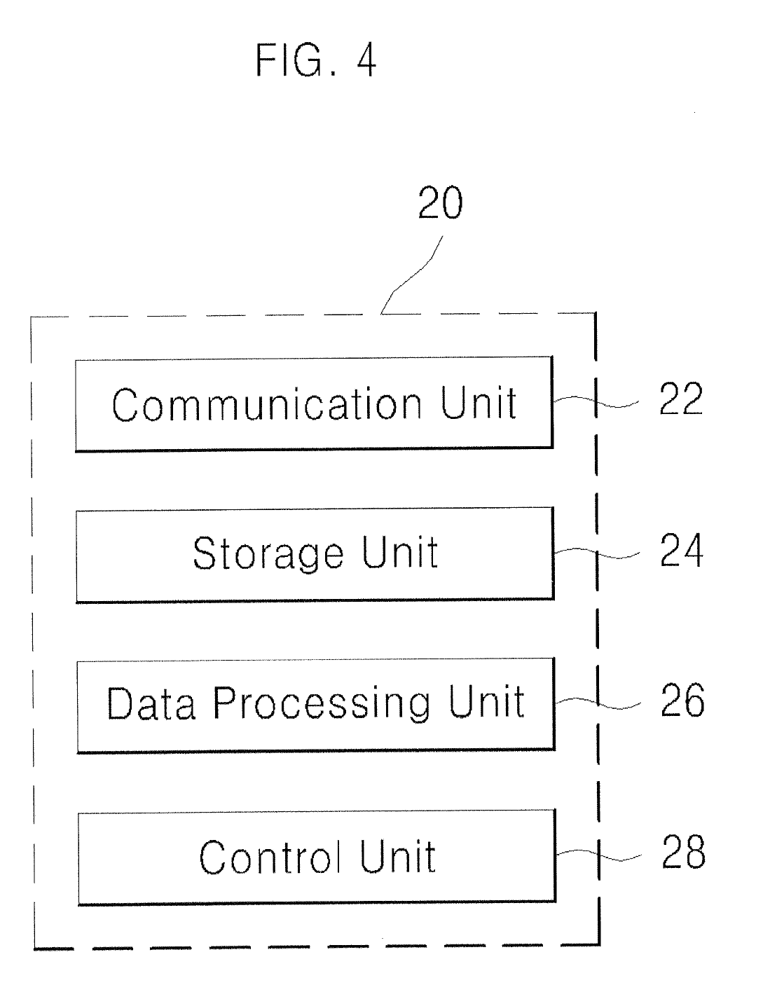

FIG. 4 is a diagram schematically illustrating a configuration of a traffic control center terminal according to an embodiment of the invention.

A traffic control center terminal 20 according to an embodiment of the invention serves as an information provider apparatus of a data transmitting and receiving system. The traffic control center terminal 20 processes traffic data collected from traffic data collecting apparatuses into traffic information of a data format in which all existing data element identifiers are removed or minimized using an item sequence of a sequence table in which data elements are arranged in a predetermined rule as an identifier and transmits the processed traffic information to traffic information utilizing apparatuses serving as a user apparatus of the data transmitting and receiving system, in collecting and processing the traffic data into the traffic information.

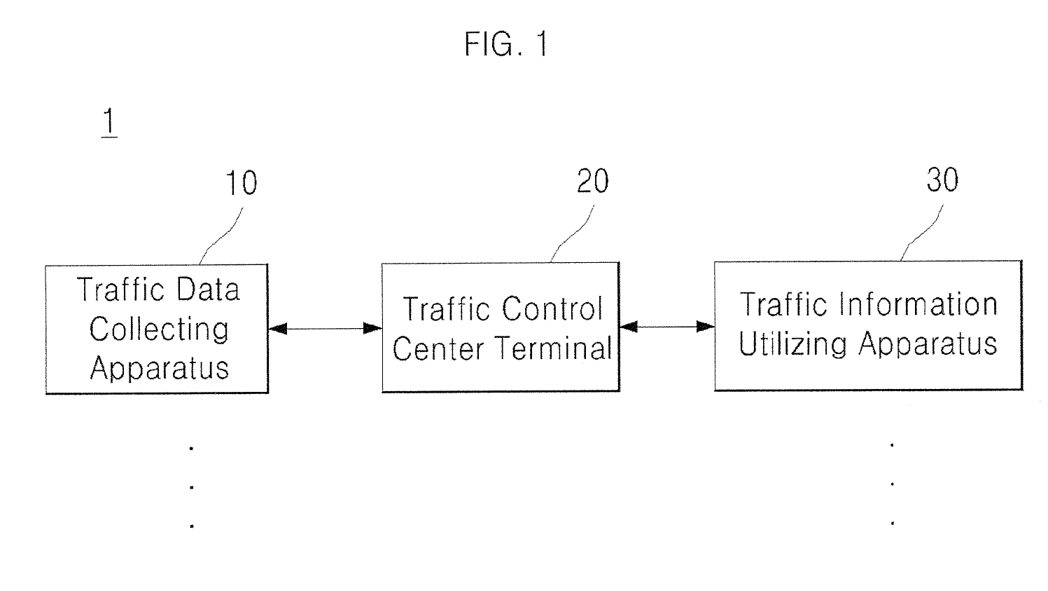

Referring to FIG. 4, the traffic control center terminal 20 according to the embodiment of the invention includes a communication unit 22, a storage unit 24, a data processing unit 26, and a control unit 28, and constitutes an intelligent transport system along with one or more traffic data collecting apparatuses 10 and one or more traffic information utilizing apparatuses 30 as shown in FIG. 1.

The communication unit 22 may include one or more modules that allows wired or/and wireless communications via networks between the traffic control center terminal 20 and the traffic data collecting apparatuses 10 or/and between the traffic control center terminal 20 and the traffic information utilizing apparatuses 30 under the control of the control unit 28. For example, the communication unit 22 may include one or more of a mobile communication module, a wired/wireless Internet module, a broadcast transmitting module, and a short-distance communication module.

The communication unit 22 receives traffic data collected by one or more traffic data collecting apparatuses connected thereto via wired/wireless networks. The communication unit transmits one or more of traffic information processed in a predetermined data format by the data processing unit 26 to be described later, a sequence table itself representing an arrangement order of data elements (each data element in this embodiment includes one or more detailed traffic data pieces) included in the traffic information, item arrangement information including one or more of an identifier, a version, and an arrangement order of the sequence table, and reference position information representing the position of an item referred to by the respective user apparatuses in the item sequence of the sequence table to one or more traffic information utilizing apparatuses. Here, the traffic information corresponds to operation information in the data transmitting and receiving system, and the detailed traffic data pieces correspond to detailed operation data pieces in the data transmitting and receiving system.

In this embodiment, the communication unit 22 can use bidirectional communications of transmitting a signal and receiving a response thereto or single-directional communications of only transmitting a broadcast signal to the traffic information utilizing apparatuses using a broadcast network (for example, a DBM network) in the course of communications with the traffic information utilizing apparatuses.

The storage unit 24 stores one or more of an operating program for driving the traffic control center terminal 20, traffic data collected by the traffic data collecting apparatus 10 and received via the communication unit 22, traffic information to be transmitted to the traffic information utilizing apparatuses 30 via the communication unit 22, a sequence table of the traffic information, the item arrangement information, and the reference position information.

The data processing unit 26 selects necessary traffic data out of the traffic data received from the traffic data collecting apparatus 10 and stored in the storage unit 24, processes the selected traffic data into traffic information having a data format corresponding to the sequence table according to the invention, and stores the traffic information in the storage unit 24. The relationship between the data format of the traffic information and the sequence table will be described below with reference to the drawings.

The traffic information of a predetermined data format processed by the data processing unit 26 has a fixed data structure in which each data element includes one or more detailed traffic data pieces, and can be distinguished depending on the arranged sequence.

The data processing unit 26 creates a sequence table corresponding to attributes of the traffic information utilizing apparatus 30 to which it is wanted to transmit traffic information in advance, and selects and arranges the traffic data in accordance with the item sequence of the previously-created sequence table to create the traffic information. Alternatively, the data processing unit 26 may create a sequence table representing the sequence in which the data elements included in the traffic information are arranged in the course of processing the traffic information, after creating the traffic information.

When a sequence table is created in advance and the version or the arrangement order of the sequence table is changed, the data processing unit 26 may additionally create one or more of item arrangement information including one or more of the version and the arrangement order of the sequence table and reference position information representing the position of an item to be referred to by each traffic information utilizing apparatus 30 in the time sequence of the changed sequence table. Various arrangement orders such as an ascending order, a descending order, an alphabet (abc) order, and a user-designated order can be used as the arrangement order of the items of the sequence table.

The control unit 28 controls the functions of the constituents of the traffic control center terminal 20.

The control unit 28 collects and stores received from the traffic data collecting apparatuses 10 via the communication unit 22 in the storage unit 24.

The control unit 28 determines a data format based on the sequence table associated with the type and the arrangement order of detailed traffic data pieces included in the data elements of the traffic information processed by the data processing unit 26 depending on the attributes (such as the positions where the traffic information utilizing apparatuses 30 are installed and used and the terminal types thereof) of the traffic information utilizing apparatuses 30.

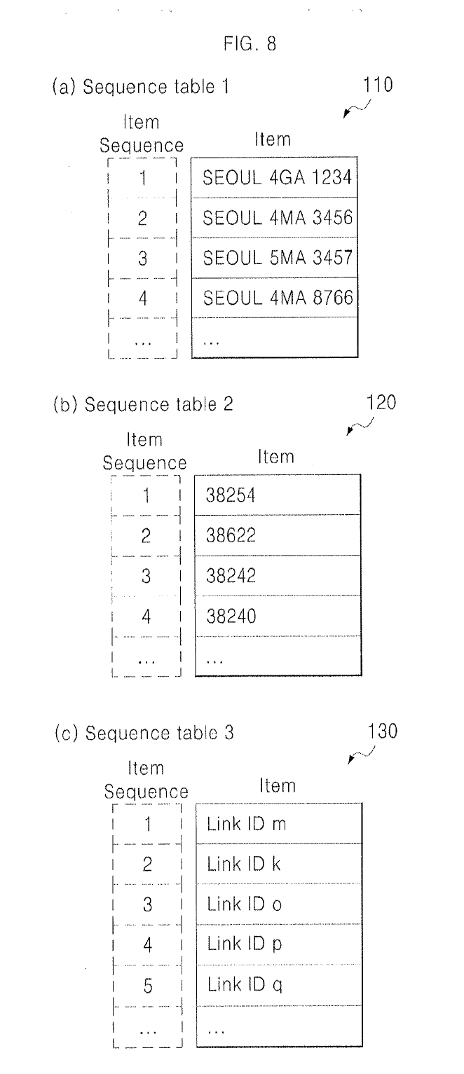

For example, when the traffic information utilizing apparatus a regular bus terminal, one or more item sequences of a bus arrangement order in the corresponding bus route, a bus stop order in the bus route, and a link order with bus stops in the bus route as nodes can be provided as a sequence table for determining a data format of the traffic information. This example is shown in FIG. 8 and will be described later in detail.

In this embodiment, the traffic control center terminal 20 and the traffic information utilizing apparatuses 30 have only to recognize the same item sequence. Therefore, by using a sequence used to create the traffic information as the item sequence of a sequence table, the traffic control center terminal 20 and the traffic information utilizing apparatuses 30 can use the sequence table having the same item sequence. When the sequence used to create the traffic information is not available, the traffic control center terminal 20 can rearrange the items of the sequence table with a predetermined criterion and then can transmit information thereon to the traffic information utilizing apparatus 30.

When the rearrangement of the sequence table is not possible, the traffic control center terminal 20 can transmit the changed sequence table so that all the traffic information utilizing apparatuses 30 have the same sequence table. For example, when a new road is constructed, the traffic information utilizing apparatuses 30 do not have information on the road and thus the traffic control center terminal 20 needs to transmit the sequence table itself.

This sequence table may have map information as shown in (c) of FIG. 8. The sequence table shown in (c) of FIG. 8 shows a constant data length. When data pieces of the links are different from each other, the links may be separated by separators.

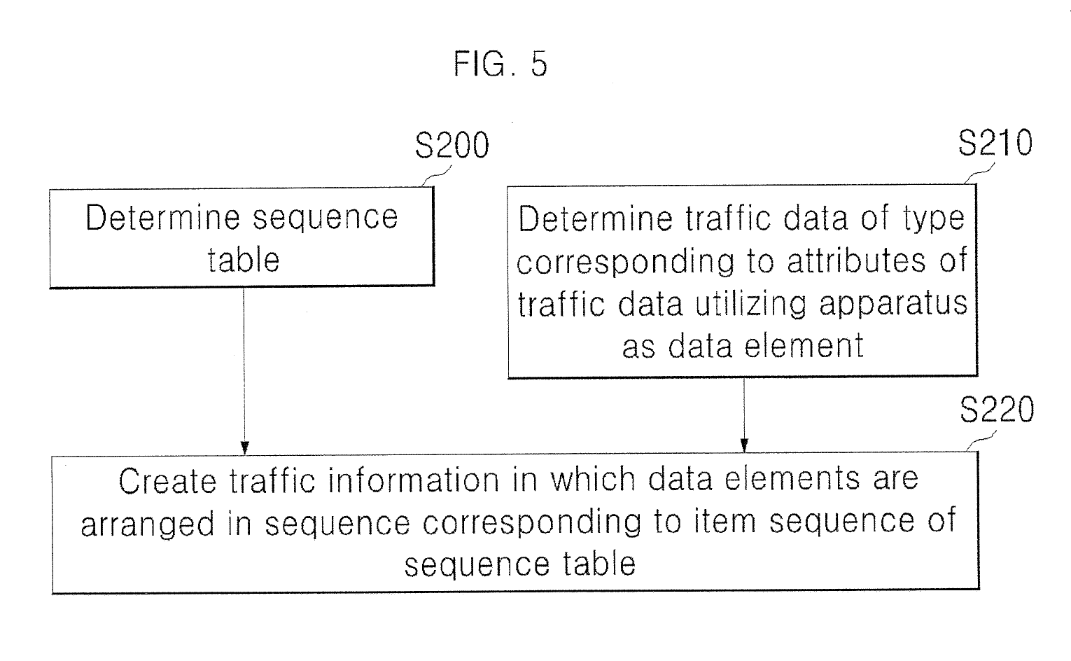

FIG. 5 is a flowchart illustrating a traffic information creating method which is performed by the traffic control center terminal according to the embodiment of the invention. The steps shown in FIG. 5 can be performed by constituents of the traffic control center terminal 20 shown in FIG. 4.

In step S200, the data processing unit 26 determines a sequence table corresponding to the attributes of a traffic information utilizing apparatus. The attributes or the sequence of the items included in the sequence table can be changed depending on the attributes such as the type and the position of the traffic information utilizing apparatus.

In step S210, the data processing unit 26 determines such a type of traffic data to correspond to the attributes of the traffic information utilizing apparatus out of the traffic data collected by the traffic data collecting apparatuses as one or more detailed traffic data pieces included in the data elements.

Step S200 and step S210 may be inverted in the order or may be simultaneously performed depending on embodiments. That is, the sequence table may be first created and then a part of the traffic data may be determined as the data elements in accordance with the item sequence of the sequence table. Alternatively, a part of the traffic data may be first determined as the data elements and then the items and the sequence of the sequence table may be determined in accordance with the arrangement order of the data elements.

In step S220, the data processing unit 26 processes the traffic data in the order corresponding to the item sequence of the sequence table and creates traffic information in which the data elements are arranged.

The traffic information and the sequence table created through the use of the above-mentioned processes will be described below with reference to the drawings.

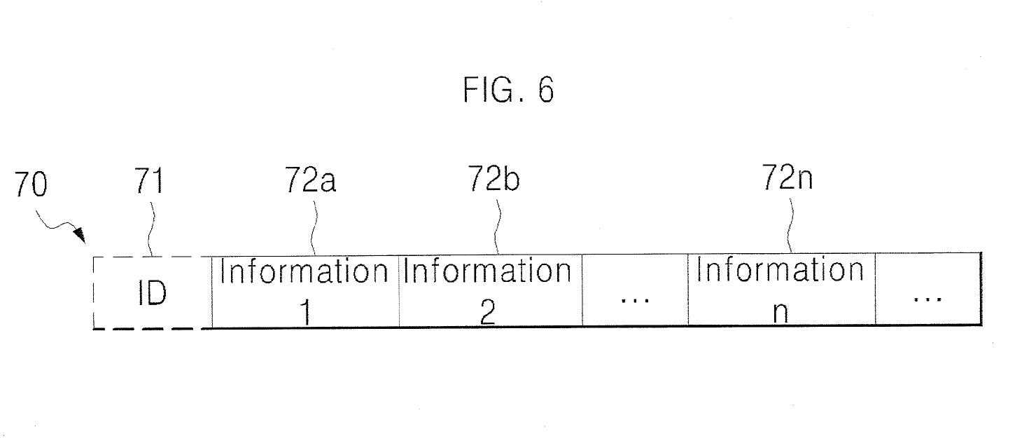

FIG. 6 is a diagram illustrating an example of traffic information having a predetermined data format, which is processed by the data processing unit of the traffic control center terminal according to the embodiment of the invention. FIG. 7 is a diagram illustrating an example of the sequence table.

Referring to FIG. 6, traffic information 70 processed by the data processing unit 26 includes a table identifier 71 and one or more data elements 72a, 72b, . . . , 72n (collectively referred to as 72).

The table identifier 71 is an identifier for identifying a sequence table in which information pieces for identifying one or more data elements 72 arranged in the subsequent stage are arranged in an item sequence. That is, the table identifier identifies a sequence table in which items representing details of one or more data elements 72 arranged in the subsequent stage are arranged in a predetermined rule.

The table identifier 71 may have position information, version information, layer information, or data information. When the table identifier includes only one thereof, it can be deleted. When the same table identifier 71 is referred to, it can be deleted. That is, when it is not necessary to identify the items corresponding to one or more data elements 72 arranged in the subsequent stage, the table identifier 71 may be deleted. For example, when traffic information relates to a specific route bus (for example, 505 route bus) and the traffic information is received by only a terminal installed in the 505 route bus, the terminal installed in the 505 route bus can understand that the traffic information relates to the 505 route bus even if the table identifier 71 is not known. Accordingly, in this case, the table identifier 71 can be deleted from the traffic information 70

Each data element 72 includes one or more detailed traffic data pieces.

The data elements 72 belonging to the traffic information 70 have the same data structure, but may have different data structures if necessary. When the data elements have different data structures, the data elements may be partitioned by separators.

The data structure can be created by a user. The data structure can be defined as a structure having a fixed position and a fixed size, or the data structure and the length thereof may be defined using a tag, like XML.

An example of a sequence table is shown in FIG. 7.

In the sequence table shown in FIG. 7, the link IDs are arranged in the order of ID1, ID2, ID3, ID4, and ID5. Information pieces of the actual positions of the links may be sequentially arranged instead of the link IDs in some examples.

In the invention, a sequence table of which the item sequence can be used as an identifier may include all information pieces which can be arranged one-dimensionally in a fixed sequence, such as layer names, time schedules, postal codes, road numbers, and phone numbers.

When the table identifier 71 of the traffic information 70 shown in FIG. 6 represents the sequence table 100 shown in FIG. 7, it can be confirmed that “information 1” which is a first data element 72a of the traffic information 70 is information on a link identified by ID 1 which is the first item of the sequence table 100. It can be also confirmed that “information 2” to “information n” which are second to n-th data elements 72b to 72n of the traffic information 70 are information on links identified by ID2 to IDn which are second to n-th items of the sequence table 100.

The data elements 72 of the traffic information 70 can be displayed in various ways such as a text, an image, a graphic, and an audio.

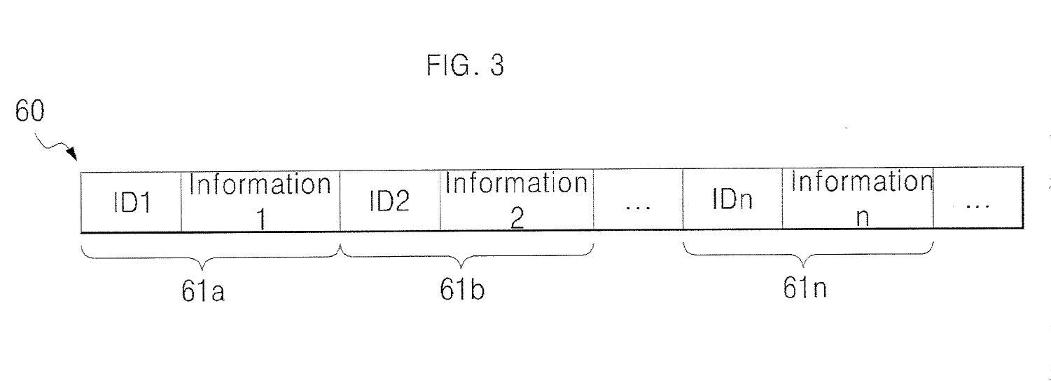

The sequence table shown in FIG. 7 has an attribute that it is not changed often after it is once created. Therefore, since such a sequence table is not often transmitted from the traffic control center terminal 20 to the traffic information utilizing apparatuses 30, it is possible to greatly reduce a data volume to be transmitted, compared with a case where traffic information is always transmitted to include identifiers in data elements (as shown in FIG. 3).

The transmission party (the traffic control center terminal 20) and the reception party (the traffic information utilizing apparatus 30) need to have the same version of the sequence table. Therefore, when the version of the sequence table is not matched, the reception party can request the transmission party for a new version of sequence table, or can request for the arrangement order of the new version of sequence table and update the sequence table stored in the reception party, or can request for change information on the reference positions of the items referred to by the reception party in the new version of sequence table and register the change information.

When a method of determining the sequence is present, the sequence table itself can be deleted. For example, when the number of items is fixed and the item sequence can be determined by arrangement or the like, the items present in the sequence table and the sequence thereof can be inferred even if the sequence table itself is not present.

In case of traffic information, for example, sequence tables are created in the units of administrative districts (for example, in the units of districts such as Gangnam-gu and Seocho-gu), specific road links can be used as identifiers (such as ID1, ID2, . . . ) as shown in FIG. 7 by using roads located in each administrative district as sequence table names (table identifiers) and item sequences as described above. Here, a sequence table having one or more link IDs as an item sequence means a map and the sequence table name can be displayed as map ID.

When it is not necessary to identify the sequence table name, the sequence table name can be deleted. For example, when a sequence table is used only in Seocho-gu, the sequence table of the map ID has the same name and the road links of the map ID of Seocho-gu can be identified using only the item sequence. Accordingly, in this case, the map ID can be deleted.

A map itself may be used as a sequence table. When mountains, rivers, and the like are present in a different layer, a sequence table representing traffic information may be used as a road layer. In this case, the link IDs may not be displayed in a particular sequence table, the sequence displayed on the map may be replaced with the item sequence, and the map may serve as the above-mentioned sequence table.

When positions are expressed in this way, the positions may be expressed by absolute coordinates (for example, WGS84) or relative coordinates (for example, distances from the left-top corner or other reference points in a two dimension) expressed relative values in the map ID, in addition to the link IDs.

FIG. 8 is a diagram illustrating examples of a sequence table of traffic information created by the traffic control center terminal according to the embodiment of the invention. FIG. 9 is a diagram illustrating examples of traffic information.

A sequence table of a bus route (for example, 505 route) is shown in FIG. 8. Traffic information on the bus route is shown in FIG. 9.

(a) of FIG. 8 shows a sequence table (sequence table 1 110) of buses of route number 505, (b) of FIG. 8 shows a sequence table (sequence table 2 120) of bus stops of route number 505, and (c) of FIG. 8 shows a sequence table (sequence table 3 130) of links of route number 505. Here, in (b) of FIG. 8, bus stops are displayed by bus stop IDs, but actual positions of bus stops may be displayed in some examples.

Referring to (a) of FIG. 9, traffic information 80 representing positions of the buses of route number 505 is shown. Each data element includes two detailed traffic data pieces [Da, Db], where the first detailed traffic data piece [Da] represents a route link at which a bus is located and the second detailed traffic data piece [Db] represents the relative position (for example, expressed by percentage) of a bus in the corresponding route link.

In the relationship between sequence table 1 110 and sequence table 3 130, the first data element 81a represents that the first bus (SEOUL 4GA 1234) is present at the start point (for example, the start point of the bus route) of the first link (Link ID m) of the route and the second data element 81b represents that the second bus (SEOUL 4MA 3456) is present at a position of 50% of the third link (Link ID o) of the route.

Accordingly, it can be seen that it is possible to greatly reduce the data volume while maintaining information quality by using a sequence table and an item sequence instead of vehicle IDs and route IDs.

Referring to (b) of FIG. 9, traffic information 90 on bus stops of route number 505 is shown. Each data element includes three detailed traffic data pieces [Da, Db, Dc], whereby the first detailed traffic data piece [Da] represents the number of persons getting on board at the corresponding bus stop, the second detailed traffic data piece [Db) represents the number of persons getting off at the corresponding bus stop, and the third detailed traffic data piece [Dc] represents the time at which the bus passes through the corresponding bus stop lately.

In the relationship with sequence table 2 120, the first data element 91a [23,0,1:40] of the traffic information 90 shows that the number of persons getting on board at the first bus stop 38254 is 23, the number of persons getting off is 0, and 1 minute and 40 seconds passes after the bus of route number 505 passes through the bus stop lately.

The second data element 91b [3,10,0:21] of the traffic information 90 shows that the number of persons getting on board at the second bus stop 38622 is 3, the number of persons getting off is 10, and 0 minutes and 21 seconds passes after the bus of route number 505 passes through the bus stop lately.

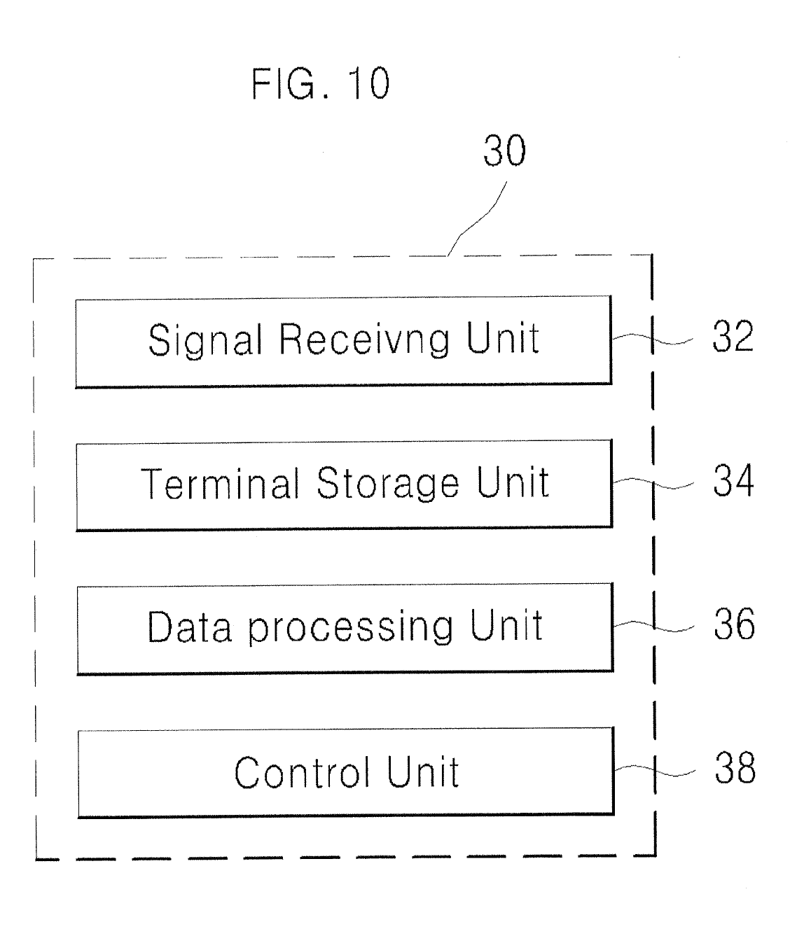

FIG. 10 is a diagram schematically illustrating a configuration of a traffic information utilizing apparatus according to the embodiment of the invention.

The traffic information utilizing apparatus according to the embodiment of the invention receives and stores traffic information having a predetermined data format from a traffic control center terminal, extracts traffic information suitable for equipment in which the traffic information utilizing apparatus is installed through the use of data processes on the traffic information, and performs a predetermined operation (for example, signal light control, screen display, and path guidance).

Referring to FIG. 10, the traffic information utilizing apparatus 30 according to the embodiment of the invention includes a signal receiving unit 32, a terminal storage unit 34, a data processing unit 36, and a control unit 38.

The signal receiving unit 32 may include one or more modules that allows wired or/and wireless communications via networks between the traffic control center terminal 20 and the traffic data collecting apparatus 10 under the control of the control unit 28. For example, the signal receiving unit 32 may include one or more of a mobile communication module, a wired or/and wireless Internet module, a broadcast receiving module, and a short-distance communication module.

The signal receiving unit 32 receives a center signal including traffic information of a predetermined data format transmitted from the traffic control center terminal 20. When a sequence table is registered at the first time or the item sequence of a sequence table is changed and the sequence table is stored in the terminal storage unit 34, a center signal including one or more of the sequence table and the item arrangement information is further received. When the sequence table is not stored in the terminal storage unit 34 and only the reference position of an item to be referred to by the traffic information utilizing apparatus 30, a center signal including the reference position information is further received.

An operating program for driving the traffic information utilizing apparatus 30 and one or more of the traffic information, the sequence table, the item arrangement information, and the reference position information received by the signal receiving unit 32 are stored in the terminal storage unit 34.

The data processing unit 36 performs a data process on the traffic information newly received via the signal receiving unit 32 in accordance with a predetermined data processing method using the sequence table stored in the terminal storage unit 34, and extracts detailed traffic data corresponding to the traffic information utilizing apparatus 30.

Here, the data processing unit 36 uses the item sequence of the sequence table corresponding to the traffic information as an identifier so as to identify necessary data elements out of plural data elements included in the traffic information.

The data processing unit 36 checks whether the newest sequence table corresponding to the traffic information received via the signal receiving unit 32 is stored in the terminal storage unit 34, and stores the newest sequence table in the terminal storage unit 34 when the newest sequence table is not stored.

The storage of the newest sequence table can be carried out by storing the sequence table included in the center signal as it were or by comparing the sequence table included in the center signal with the sequence table stored in the terminal storage unit 34 and storing the sequence table included in the center signal when both are different from each other. Alternatively, when the newest version of sequence table is not stored in the terminal storage unit 34 as the result of comparison of the versions of the sequence tables using the sequence table information included in the center signal, the newest sequence table may be requested to the traffic control center terminal 20 and may be received therefrom. Alternatively, by checking the arrangement order using the sequence table information included in the center signal and arranging the items of the sequence table stored in the terminal storage unit 34 in accordance with the arrangement order, the sequence tables stored in the traffic control center terminal 20 and the traffic information utilizing apparatus 30 may be made to agree to each other.

It is assumed that the sequence table is stored in the terminal storage unit 34, but depending on the type of the traffic information utilizing apparatus 30, the sequence table itself is not stored and only the reference position information of the items to be referred to in the sequence table by the sequence table may be stored in the terminal storage unit 34. In this case, the information on the newest reference position instead of the newest sequence table is received from the traffic control center terminal 20 and is stored in the terminal storage unit 34.

The control unit 38 controls the functions of constituents of the traffic information utilizing apparatus 30.

The control unit 38 stores the traffic information included in a signal received via the signal receiving unit 32 in the terminal storage unit 34, and stores one or more of the sequence table, the item arrangement information, and the reference position information in the terminal storage unit 34.

The control unit 38 performs a predetermined operation (for example, signal control, screen display, and path guidance) using the detailed traffic data extracted by the data processing unit 36. The data process using the sequence table will be described below in detail with reference to the drawings.

The predetermined operation includes the following examples. For example, when the traffic information utilizing apparatus 30 is a signal light controller, detailed traffic data (signal light control information) corresponding to the sequence of crossroads is extracted and the signal light display is controlled on the basis of the extracted data so that vehicles or/and pedestrians smoothly pass the crossroads.

In another example, when the traffic information utilizing apparatus 30 is a regular bus terminal, detailed traffic data (for example, positions of buses, the number of persons getting in or off, and passage times of bus stops) on preceding buses or/and following buses based on the arrangement order in a bus route is extracted and the extracted data is displayed on a screen for the confirmation of a driver, whereby the driver can maintain an appropriate arrangement interval from the preceding and following vehicles so that bus passengers can use the buses of the corresponding route.

In another example, when the traffic information utilizing apparatus 30 is a navigation terminal, detailed traffic data (for example, traffic situation within predetermined distance from the location of the vehicle or on corresponding road link/map) based on the road link in which a vehicle having the traffic information utilizing apparatus 30 mounted thereon or the order of a map is extracted and path guidance reflecting the detailed traffic data can be provided.

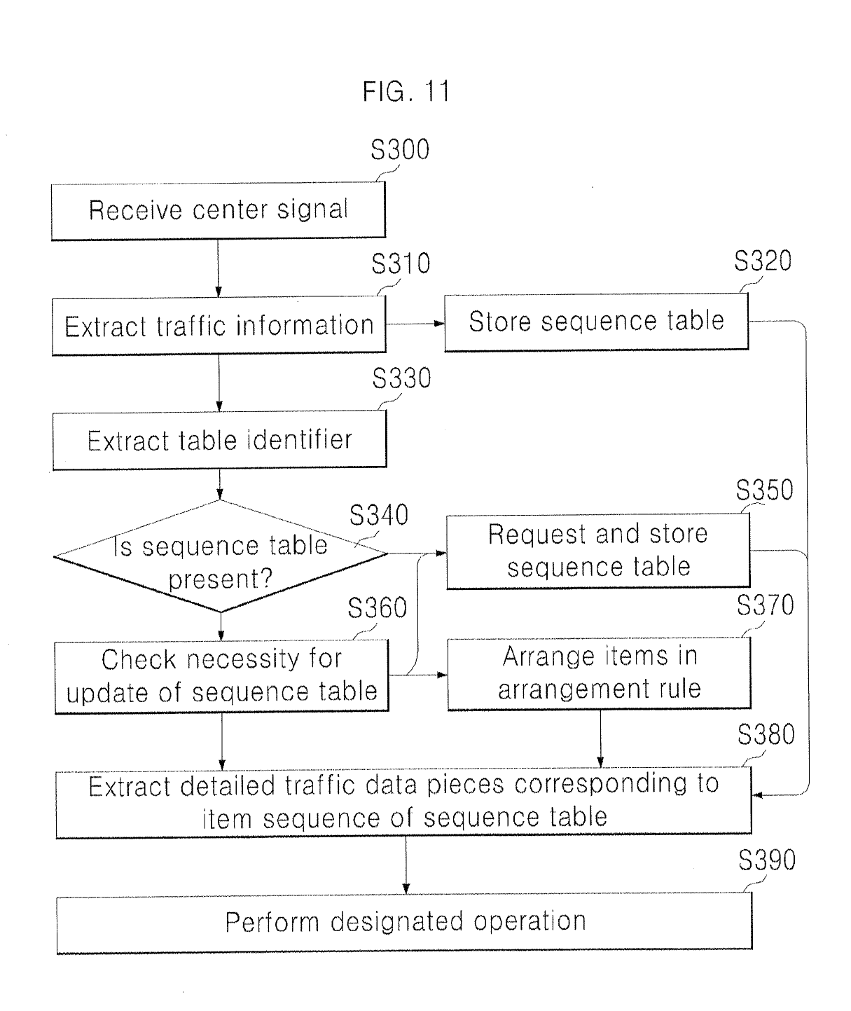

FIG. 11 is a flowchart illustrating a data processing method which is performed by the traffic information utilizing apparatus according to the embodiment of the invention. The steps shown in FIG. 11 can be performed by constituents of the traffic information utilizing apparatus 30 shown in FIG. 1.

In step S300, the signal receiving unit 32 receives a center signal transmitted from the traffic control center terminal 20. The center signal may be a signal transmitted via a bidirectional communication network or via a broadcast network. The center signal includes traffic information having a data format shown in FIG. 6. The center signal may further include a sequence table or sequence table information.

In step S310, the data processing unit 36 extracts the traffic information included in the center signal.

When a sequence table is included in the center signal, the data processing unit 36 extracts the sequence table included in the center signal and stores the extracted sequence table in the terminal storage unit 34 in step S320 and then the process flow goes to step S380. In this case, when the sequence table corresponding to the traffic information is stored in advance in the terminal storage unit 34, the data processing unit may check whether the sequence table should be updated and stored through comparison of versions or the like and may update and store the sequence table.

When the sequence table is not included in the center signal, the data processing unit extracts a table identifier of the traffic information in step S330. When the table identifier is not included in the traffic information, the process flow goes to step S380.

In step S340, the data processing unit 36 checks whether the sequence table corresponding to the table identifier is stored in the terminal storage unit 34.

When the sequence table corresponding to the table identifier is not stored, the data processing unit 36 requests the traffic control center terminal 20 for transmission of the sequence table and receives and stores the sequence table in the terminal storage unit 34 in response to the request in step S350, and then the process flow goes to step S380.

When the sequence table corresponding to the table identifier is stored, the data processing unit 36 determines necessity for updating the sequence table in step S360. The determination of necessity for update can be performed by checking whether the version of the sequence table included in the sequence table information included in the center signal is the newest version.

When there is no necessity for update, the process flow goes to step S380. When there is necessity for update, the data processing unit 36 requests the traffic control center terminal 20 for transmission of the sequence table and receives and stores the sequence table in the terminal storage unit 34 in step S350, and then the process flow goes to step S380.

Alternatively, when there is a necessity for update and the arrangement order is included in the sequence table information included in the center signal received in step S300, the data processing unit rearranges the items of the sequence table stored in the terminal storage unit 34 in accordance with the arrangement order included in the center signal in step S370, and then the process flow goes to step S380.

Through the processes of steps 320 and 350 or step S370, the sequence tables of the transmission party (the traffic control center terminal 20) and the reception party (the traffic information utilizing apparatus 30) are made to be equal to each other.

In step S380, the data processing unit 36 identifies and extracts detailed traffic data corresponding to the traffic information utilizing apparatus 30 in accordance with the arrangement order of the sequence table stored in the terminal storage unit 34.

In step S390, the control unit 38 performs a predetermined operation using the extracted detailed traffic data.

It is assumed above that the sequence table itself is stored in the terminal storage unit 34, but depending on the type of the traffic information utilizing apparatus 30, the sequence table itself is not stored and only the reference position information on the positions of the items to be referred to in the sequence table by the traffic information utilizing apparatus 30 may be stored in the terminal storage unit 34. In this case, it is determined whether the reference position information is stored instead of the sequence table, the reference position information is requested and stored, and the necessity for update thereof is checked in steps S340, S350, and S360. The process of step S370 is not performed, and when the newest reference position information is received from the traffic control center terminal 20 and is stored in the terminal storage unit 34, detailed traffic data of the sequence order corresponding to the reference position information is extracted out of the data elements of the traffic information in step S380.

The above-mentioned traffic information creating method or/and the above-mentioned traffic information processing method may be embodied as automated procedures based on the time-series order by a program built or installed in a digital processor. Codes and code segments of the program will be easily inferred by computer programmers skilled in the art. The program can be stored in a computer-readable recording medium and can be read and executed by a digital processor to embody the above-mentioned methods. The recording medium includes a magnetic recording medium, an optical recording medium, and a carrier wave medium.

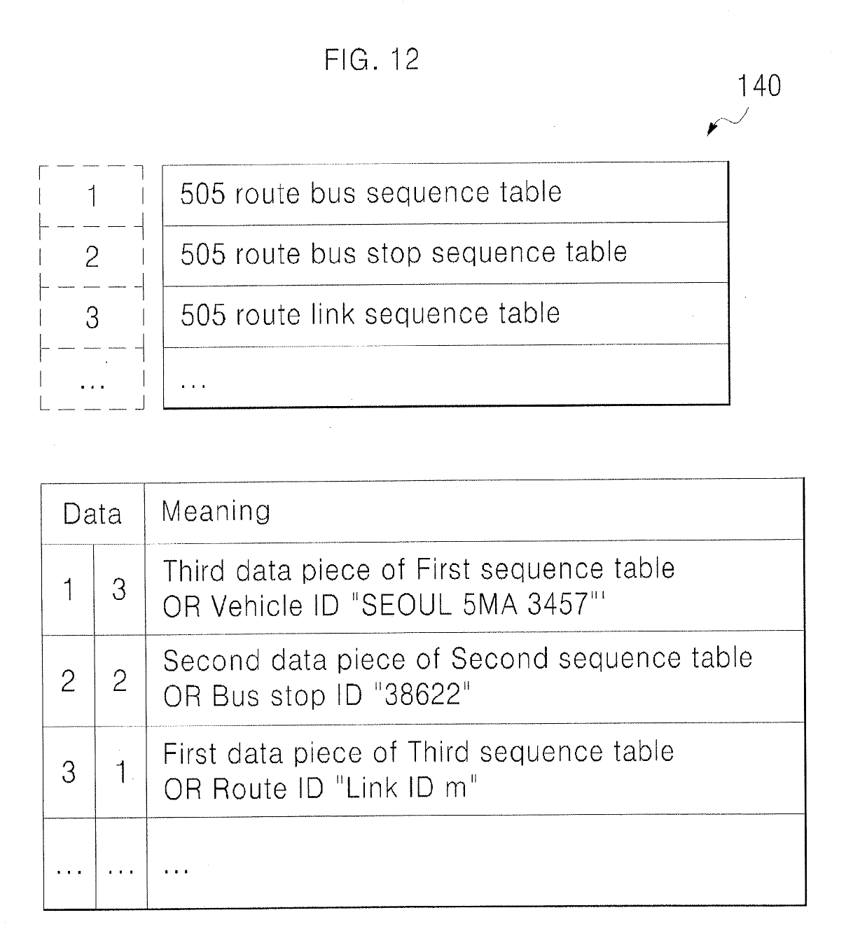

FIG. 12 is a diagram illustrating a method using a sequence table and an item sequence as identifiers according to another embodiment of the invention.

Referring to FIG. 12, an example where sequence tables are used as items of another sequence table is shown.

Referring to (a) of FIG. 12, a 505 route bus sequence table (sequence table 1) 110, a 505 route bus stop sequence table (sequence table 2) 120, a 505 route link sequence table (sequence table 3) 130, and the like are sequentially included as items of a sequence table 140.

In this case, when referring to the sequence table 140, data “13” represents the third data piece of the first sequence table (sequence table 1) 110, that is, bus ID “SEOUL 5MA 3457”. Data “22” represents the second data piece of the second sequence table (sequence table 2) 120, that is, bus stop ID “38622”. Data “31” represents the first data piece of the third sequence table (sequence table 3) 130, that is, route ID “Link ID m”.

The names of the sequence tables may be deleted if necessary.

Since the traffic information created according to the embodiment of the invention, for example, for buses has a structure which allows all the buses to share information of the buses, various running operations which could not be achieved by a single bus (or route, or section) can be implemented.

If necessary, by together managing the bus arrangement intervals of various regular buses running in a section from stop A to stop B, a common route section can be managed together so that passengers using the buses in the section can use the buses with very small bus arrangement intervals.

Alternatively, congestion at bus stops located in the section can be dispersed by adjusting the arrangement intervals of buses running on a single road, the time consumed at the bus stops can be reduced to raise the operating speed of buses by causing some buses to pass through some bus stops which are estimated to have no passengers by analysis of the traffic information without stopping or the like.

It is assumed above that the data transmitting and receiving system is an intelligent transport system. A data creating method and a data processing method in a data transmitting and receiving system in which an information provider apparatus and a user apparatus are connected to each other via a network (including a broadcast network) will be described below.

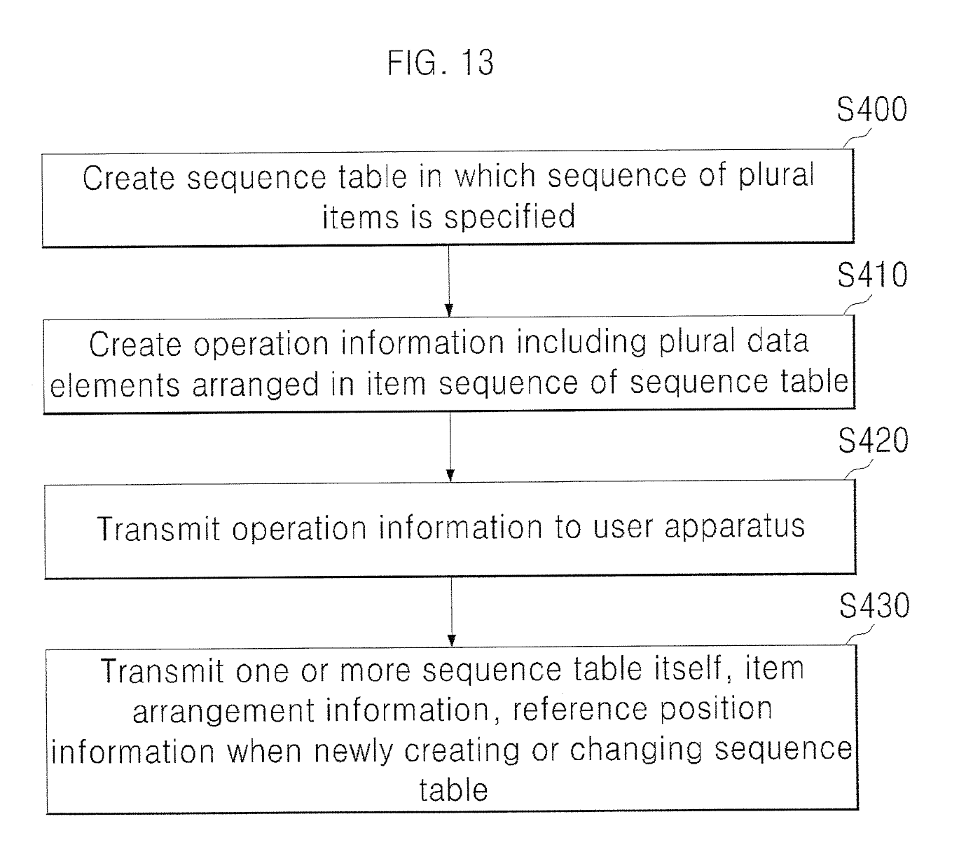

FIG. 13 is flowchart illustrating a data creating method using an item sequence of a sequence table as an identifier, which is performed by an information provider apparatus in a data transmitting and receiving system according to the invention.

In step S400, the information provider apparatus creates a sequence table in which a sequence of plural items is specified depending on attributes of the user apparatus. The sequence table may include other sequence tables as items as show in FIG. 12.

In step S410, the information provider apparatus creates operation information including plural data elements arranged in the item sequence of the sequence table. Each data element includes one or more detailed operation data pieces as shown in FIG. 9. The operation information may further include a sequence table identifier for identifying a sequence table in which the item sequence of the data elements is specified as shown in FIG. 6.

In step S420, the information provider apparatus transmits the operation information to the user apparatus. At this time, the operation information can be included in a broadcast signal transmitted from the information provider apparatus to any user apparatus via a broadcast network.

In step S430, when the sequence table is newly created or changed, the information provider apparatus can transmit one or more of item arrangement information of the newly-created or changed sequence table, the newly-created or changed sequence table itself, and a reference position of the user apparatus based on the newly-created or changed sequence table.

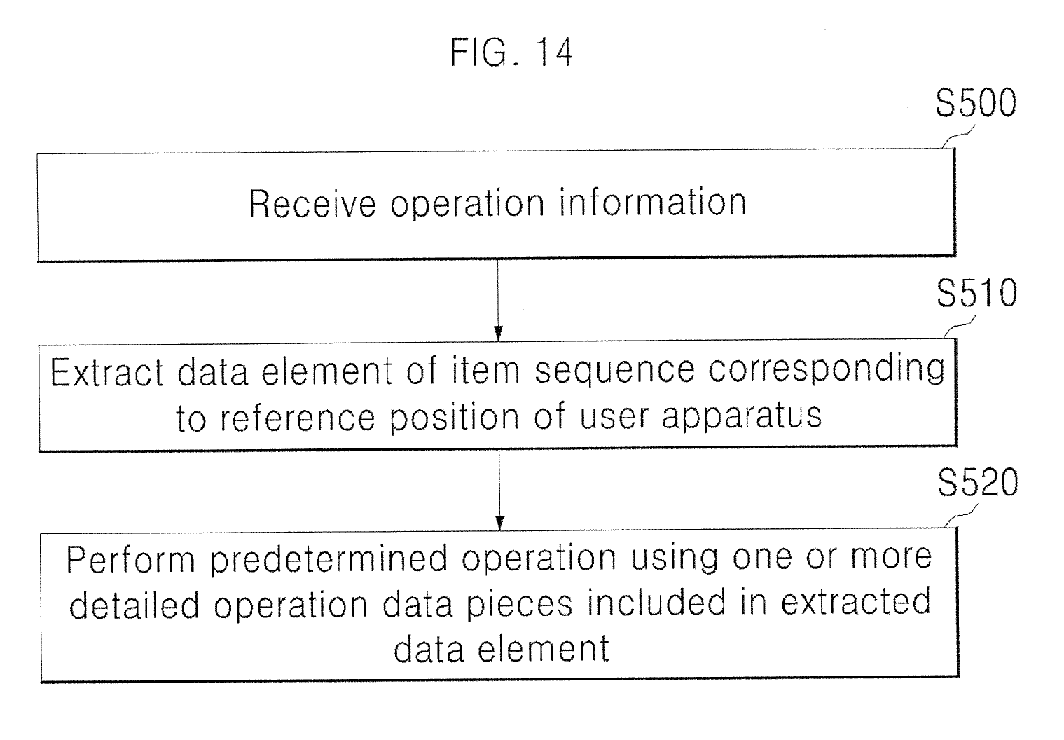

FIG. 14 is a flowchart illustrating a data processing method using an item sequence of a sequence table as an identifier which is performed by a user apparatus in the data transmitting and receiving system according to the invention.

In step S500, the user apparatus receives operation information transmitted from the information provider apparatus. The operation information includes plural data elements arranged in the item sequence of the sequence table in which the sequence of the plural items is specified, and each data element includes one or more detailed operation data pieces.

The user apparatus receives a broadcast signal transmitted from the information provider apparatus via a broadcast network. The operation information is included in the broadcast signal.

When a sequence table is received along with the operation information in step S500, the user apparatus considers the sequence table to be the newest sequence table and stores the received sequence table.

In step S510, the user apparatus extracts data elements of the item sequence corresponding to the reference position of the user apparatus out of the operation information.

Here, the user apparatus may store the sequence table or the reference position information based on the sequence table.

When the information provider apparatus newly creates a sequence table, the user apparatus receives and stores the newly-created sequence table itself or the reference position information based on the newly-created sequence table. Alternatively, the user apparatus may receive item arrangement information on the item sequence of the newly-created sequence table and may newly create and store a sequence table having the item sequence corresponding thereto.

When the sequence table is changed in the information provider apparatus, the user apparatus receives and stores the changed sequence table itself or reference position information based on the changed sequence table. Alternatively, the user apparatus may receive item arrangement information on the items sequence of the changed sequence table and may rearrange and store the items of the stored sequence table on the basis of the newly-received item arrangement information.

In step S520, the user apparatus performs a predetermined operation using one or more detailed operation data pieces included in the extracted data element.

The predetermined operation varies depending on the type or/and the attributes of the user apparatus.

For example, when the data transmitting and receiving system is a streetlight system, the user apparatus is a streetlight controller installed in a streetlight, and can turn on and off the streetlight depending on the lighting time and the lighting-out time or can cause the streetlight to flicker for a predetermined time.

The above-mentioned data creating method or/and the above-mentioned data processing method may be embodied as automated procedures based on the time-series order by a program built or installed in a digital processor. Codes and code segments of the program will be easily inferred by computer programmers skilled in the art. The program can be stored in a computer-readable recording medium and can be read and executed by a digital processor to embody the above-mentioned methods. The recording medium includes a magnetic recording medium, an optical recording medium, and a carrier wave medium.

According to the aspects of the invention, it is possible to reduce a data volume of existing identifiers to reduce a data volume to be transmitted by using an item sequence of a sequence table which are commonly stored by both a transmission party and a reception party.

It is also possible to reduce an error due to communication congestion in the course of transmitting information, to reduce communication cost and facility cost, and to improve data quality.

It is possible to transmit the same information with a volume smaller than that in the related art and to greatly enhance a reception success rate when data should be re-transmitted in transmission via a broadcast network.

Those skilled in the art will understand that the invention can be modified in various specific forms without changing the technical concept or essential features of the invention. Accordingly, it should be understood that the above-mentioned embodiments are not definitive but exemplary in all the points of view. The scope of the invention is defined by the appended claims, not by the above-mentioned detailed description, and it should be understood that all modifications and changes derived from the scope of the claims and equivalents thereof belong to the scope of the invention.

1. A data processing method using an item sequence of a sequence table as an identifier in a user apparatus connected to an information provider apparatus via a network, comprising the steps of:
(a) causing the user apparatus to receive operation information to be transmitted from the information provider apparatus, wherein the operation information includes a plurality of data elements arranged in accordance with an item sequence of a sequence table in which the sequence of a plurality of items is specified and each data element includes one or more detailed operation data pieces;
(b) extracting the data element of the item sequence corresponding to a reference position of the user apparatus out of the operation information; and
(c) performing a predetermined operation using the one or more detailed operation data pieces included in the extracted data element.

2. The data processing method according to claim 1, wherein the user apparatus stores the sequence table or reference position information based on the sequence table.

3. The data processing method according to claim 1, further comprising a step of:
causing the user apparatus receives item arrangement information of a changed sequence table and to rearrange the items of the sequence table stored in the user apparatus in response to the received item arrangement information, when the sequence table is changed in the information provider apparatus.

4. The data processing method according to claim 1, further comprising a step of:
causing the user apparatus to receive and store information on a reference position of the user apparatus which is newly created or changed on the basis of a newly-created or changed sequence table, when the sequence table is newly created or changed in the information provider apparatus.

5. The data processing method according to claim 1, further comprising a step of:
causing the user apparatus to receive and store a newly-created or changed sequence table, when the sequence table is newly created or changed in the information provider apparatus.

6. The data processing method according to claim 1, further comprising a step of:
causing the user apparatus to receive item arrangement information of a newly-created sequence table and to create and store a sequence table having an item sequence corresponding to the item arrangement information, when the sequence table is newly created in the information provider apparatus, before the step of (b).

7. The data processing method according to claim 1, wherein the step of (a) includes causing the user apparatus to receive the sequence table along with the operation information, and
wherein the user apparatus stores the received sequence table before the step of (b).

8. The data processing method according to claim 1, wherein the operation information is included in a broadcast signal emitted from the information provider apparatus via a broadcast network.

9. The data processing method according to claim 1, wherein the operation information includes a sequence table identifier for identifying a sequence table in which the sequence of a plurality of items is specified, and
wherein the step of (b) includes causing the user apparatus to confirm the reference position using the sequence tables corresponding to the sequence table identifiers.

10. The data processing method according to claim 1, wherein the items of the sequence table indicate other sequence tables.

11. A data creating method using an item sequence of a sequence table as an identifier in an information provider apparatus connected to a user apparatus via a network, comprising the steps of:
(a) causing the information provider apparatus to create a sequence table in which a sequence of a plurality of items is specified depending on an attribute of the user apparatus;
(b) creating operation information including a plurality of data elements which are arranged in the item sequence of the sequence table, wherein each data element includes one or more detailed operation data pieces; and
(c) transmitting the operation information to the user apparatus.

12. The data creating method according to claim 11, further comprising a step of:
causing the information provider apparatus to transmit one or more of the newly-created or changed sequence table, item arrangement information of a newly-created or changed sequence table, and a reference position of the user apparatus based on the newly-created or changed sequence table, when the sequence table is newly created or changed.

13. The data creating method according to claim 11, wherein the operation information transmitted in the step of (c) is included in a broadcast signal emitted from the information provider apparatus via a broadcast network.

14. The data creating method according to claim 11, wherein the operation information includes a sequence table identifier for identifying a sequence table in which a sequence of a plurality of items is specified.

15. The data creating method according to claim 11, wherein the items of the sequence table indicate other sequence tables.

16. A recording medium having recorded thereon a program which can be read by a digital processor so as to perform the data processing method according to claim 1.

17. A recording medium having recorded thereon a program which can be read by a digital processor so as to perform the data creating method according to claim 11.
